(19) United States
(12) Patent Application Publication
(10) Pub. No.: US 2024/0331716 A1
(43) Pub. Date: Oct. 3, 2024

(54) LOW-LATENCY NOISE SUPPRESSION

(71) Applicant: QUALCOMM Incorporated, San Diego, CA (US)

(72) Inventors: Jacob Jon BEAN, Vista, CA (US); Rogerio Guedes ALVES, Macomb Township, MI (US); Vahid MONTAZERI, Newport Beach, CA (US); Erik VISSER, San Diego, CA (US)

(21) Appl. No.: 18/611,308

(22) Filed: Mar. 20, 2024

Related U.S. Application Data
(60) Provisional application No. 63/493,158, filed on Mar. 30, 2023.

(51) Int. Cl. G10L 21/0224; G06F 1/16; G10L 21/0232; G10L 21/0216

(52) U.S. Cl. CPC G10L 21/0224; G06F 1/163; G10L 21/0232; G10L 2021/02166

(57) ABSTRACT

A device includes one or more processors configured to obtain audio data representing one or more audio signals. The audio data includes a first segment and a second segment subsequent to the first segment. The one or more processors are configured to perform one or more transform operations on the first segment to generate frequency-domain audio data. The one or more processors are configured to provide input data based on the frequency-domain audio data as input to one or more machine-learning models to generate a noise-suppression output. The one or more processors are configured to perform one or more reverse transform operations on the noise-suppression output to generate time-domain filter coefficients. The one or more processors are configured to perform time-domain filtering of the second segment using the time-domain filter coefficients to generate a noise-suppressed output signal.

### I. CROSS-REFERENCE TO RELATED APPLICATIONS

The present application claims priority from Provisional Patent Application No. 63/493,158, filed Mar. 30, 2023, entitled “LOW-LATENCY NOISE SUPPRESSION,” the content of which is incorporated herein by reference in its entirety.

### II. FIELD

The present disclosure is generally related to low-latency noise suppression.

### III. DESCRIPTION OF RELATED ART

Hearing-related problems of various types affect a significant number of people. For example, one common problem is that even people with relatively normal hearing can find it difficult to hear speech in noisy environments, and the problem can be considerably worse for those with hearing loss. For some individuals, speech is readily intelligible only when the signal-to-noise ratio (of the speech relative to ambient noise) is above a certain level.

Wearable devices (e.g., ear buds, headphones, hearing aids, etc.) can be used to improve hearing, situational awareness, intelligibility of speech, etc. in many circumstances. Generally, such devices apply relatively simple noise suppression processes to remove as much of the ambient noise as possible. While such noise suppression processes can improve the signal-to-noise ratio sufficiently for speech to be intelligible, these noise suppression processes may also reduce situational awareness of the user since these processes attempt to simply remove as much noise as possible, thereby possibly removing important environmental cues, such as traffic sounds. Use of more complex noise suppression processes can introduce significant latency. Latency in processing real-time speech can lead to user dissatisfaction.

### IV. SUMMARY

According to one implementation of the present disclosure, a device includes one or more processors configured to obtain audio data representing one or more audio signals. The audio data includes a first segment and a second segment subsequent to the first segment. The one or more processors are configured to perform one or more transform operations on the first segment to generate frequency-domain audio data. The one or more processors are configured to provide input data based on the frequency-domain audio data as input to one or more machine-learning models to generate a noise-suppression output. The one or more processors are configured to perform one or more reverse transform operations on the noise-suppression output to generate time-domain filter coefficients. The one or more processors are configured to perform time-domain filtering of the second segment using the time-domain filter coefficients to generate a noise-suppressed output signal.

According to another implementation of the present disclosure, a method includes obtaining audio data representing one or more audio signals. The audio data includes a first segment and a second segment subsequent to the first segment. The method includes performing one or more transform operations on the first segment to generate frequency-domain audio data. The method includes providing input data based on the frequency-domain audio data as input to one or more machine-learning models to generate a noise-suppression output. The method includes performing one or more reverse transform operations on the noise-suppression output to generate time-domain filter coefficients. The method includes performing time-domain filtering of the second segment using the time-domain filter coefficients to generate a noise-suppressed output signal.

According to another implementation of the present disclosure, a non-transitory computer-readable medium stores instructions that are executable by one or more processors to cause the one or more processors to obtain audio data representing one or more audio signals. The audio data includes a first segment and a second segment subsequent to the first segment. The instructions are executable to cause the one or more processors to perform one or more transform operations on the first segment to generate frequency-domain audio data. The instructions are executable to cause the one or more processors to provide input data based on the frequency-domain audio data as input to one or more machine-learning models to generate a noise-suppression output. The instructions are executable to cause the one or more processors to perform one or more reverse transform operations on the noise-suppression output to generate time-domain filter coefficients. The instructions are executable to cause the one or more processors to perform time-domain filtering of the second segment using the time-domain filter coefficients to generate a noise-suppressed output signal.

According to another implementation of the present disclosure, an apparatus includes means for performing one or more transform operations on a first segment of audio data to generate frequency-domain audio data, where the audio data includes a first segment and a second segment subsequent to the first segment. The apparatus also includes means for processing input data based on the frequency-domain audio data as input to one or more machine-learning models to generate a noise-suppression output. The apparatus also includes means for performing one or more reverse transform operations on the noise-suppression output to generate time-domain filter coefficients. The apparatus also includes means for performing time-domain filtering of the second segment using the time-domain filter coefficients to generate a noise-suppressed output signal.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of particular aspects of a device operable to perform low-latency noise suppression, in accordance with some examples of the present disclosure.

FIG. 2 is a block diagram of illustrative aspects of the device of FIG. 1, which is operable to perform low-latency noise suppression, in accordance with some examples of the present disclosure.

FIG. 3 is a block diagram of illustrative aspects of the device of FIG. 1, which is operable to perform low-latency noise suppression, in accordance with some examples of the present disclosure.

FIG. 4 is a block diagram of illustrative aspects of the device of FIG. 1, which is operable to perform low-latency noise suppression, in accordance with some examples of the present disclosure.

FIG. 5 is a block diagram of illustrative aspects of the device of FIG. 1, which is operable to perform low-latency noise suppression, in accordance with some examples of the present disclosure.

FIG. 6 is a block diagram of illustrative aspects of the device of FIG. 1, which is operable to perform low-latency noise suppression, in accordance with some examples of the present disclosure.

FIG. 7 is a block diagram of illustrative aspects of the device of FIG. 1, which is operable to perform low-latency noise suppression, in accordance with some examples of the present disclosure.

FIG. 8 is a block diagram of illustrative aspects of the device of FIG. 1, which is operable to perform low-latency noise suppression, in accordance with some examples of the present disclosure.

FIG. 9 illustrates an example of an integrated circuit operable to perform low-latency noise suppression, in accordance with some examples of the present disclosure.

FIG. 10 is a diagram of a headset operable to perform low-latency noise suppression, in accordance with some examples of the present disclosure.

FIG. 11 is a diagram of a headset, such as a virtual reality, mixed reality, or augmented reality headset, operable to perform low-latency noise suppression, in accordance with some examples of the present disclosure.

FIG. 12 is a diagram of augmented reality glasses operable to perform low-latency noise suppression, in accordance with some examples of the present disclosure.

FIG. 13 is a diagram of a wearable device operable to perform low-latency noise suppression, in accordance with some examples of the present disclosure.

FIG. 14 is a diagram of earbuds operable to perform low-latency noise suppression, in accordance with some examples of the present disclosure.

FIG. 15 is a diagram of a particular implementation of a method of performing low-latency noise suppression that may be performed by the device of FIG. 1, in accordance with some examples of the present disclosure.

FIG. 16 is a block diagram of a particular illustrative example of a device that is operable to perform low-latency noise suppression, in accordance with some examples of the present disclosure.

### VI. DETAILED DESCRIPTION

In contexts in which latency constraints are sufficiently flexible, machine-learning based noise suppression processes can be used to reduce the magnitude of noise components of audio data, to increase the magnitude of target sound components in the audio data, or both. However, machine-learning processes and related pre-processing and post-processing can introduce significant delay. To illustrate, machine-learning noise suppression models generally operate in the frequency domain, which entails transforming audio data from a time domain to the frequency domain to generate input data for a machine-learning model. Further, after the machine-learning model processes the input data to generate noise-suppressed audio data, the noise-suppressed audio data is transformed back into the time domain for output to a user. Each of these operations introduces delay, which can lead to unacceptable latency, especially for real-time audio processing of speech.

Aspects disclosed herein enable audio processing in a manner that provides high-quality noise suppression without introducing undue latency. According to a particular aspect, noise suppression is performed in the time-domain by application of one or more time-domain filters to received audio data. Coefficients of the one or more time-domain filters are determined based on noise suppression output generated in the frequency domain by one or more machine-learning models. The time-domain filter coefficients determined based on the noise suppression output of the machine-learning model(s) provide significantly better noise suppression than traditional time-domain processes, such as adaptive noise cancellation. Further, since the time-domain filter coefficients are applied to receive audio data in the time domain, little or no latency is added by using such time-domain filter coefficients to process the audio data.

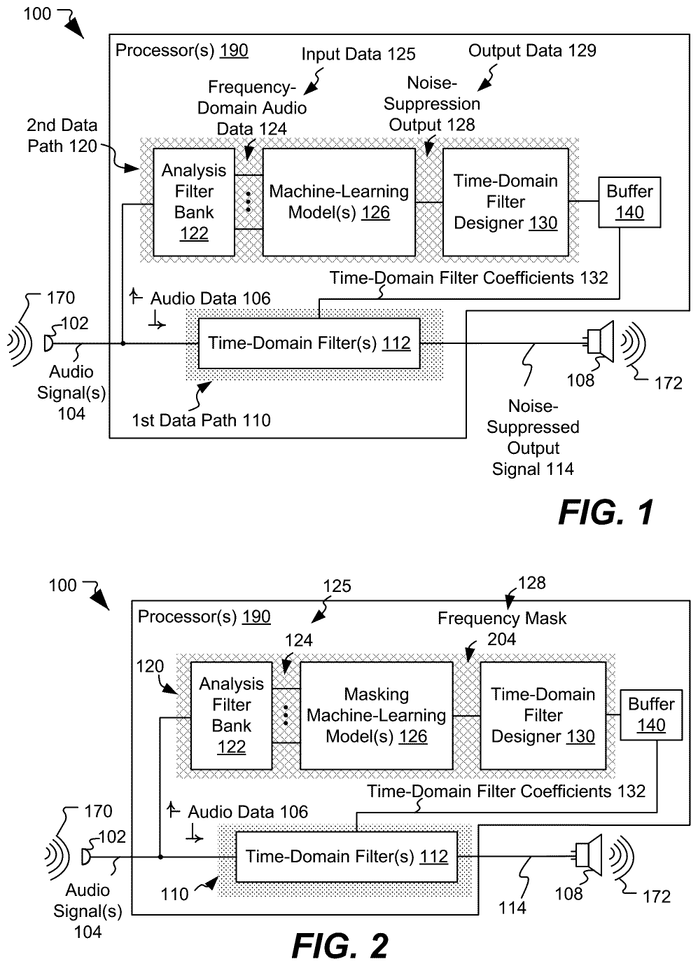

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 100 including one or more processors (“processor(s)” 190 of FIG. 1), which indicates that in some implementations the device 100 includes a single processor 190 and in other implementations the device 100 includes multiple processors 190. For ease of reference herein, such features are generally introduced as “one or more” features and are subsequently referred to in the singular or optional plural (as indicated by “(s)”) unless aspects related to multiple of the features are being described.

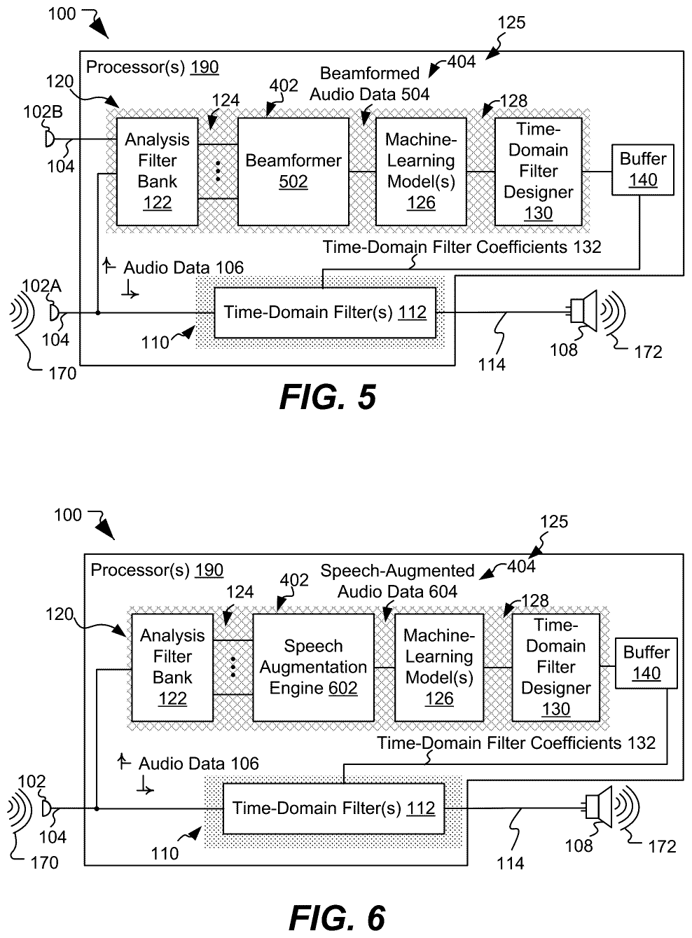

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 5, multiple microphones are illustrated and associated with reference numbers 102A and 102B. When referring to a particular one of these microphones, such as a microphone 102A, the distinguishing letter “A” is used. However, when referring to any arbitrary one of these microphones or to these microphones as a group, the reference number 102 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of particular aspects of a device 100 operable to perform low-latency noise suppression, in accordance with some examples of the present disclosure. In FIG. 1, the device 100 includes or is coupled to one or more microphones 102 and to one or more speakers 108.

The microphone(s) 102 are configured to generate audio signal(s) 104 based on sound 170 detected in an ambient environment. The sound 170 can include a target sound, such as speech, as well as non-target sounds (e.g., noise). The device 100 is configured to process audio data 106 representing the audio signal(s) 104 to generate a noise-suppressed output signal 114, which can be used to drive the speaker(s) 108 to generate output sound 172. In the output sound 172, components of the audio data 106 corresponding to the target sound(s) are emphasized, components of the audio data 106 corresponding to the non-target sound(s) are de-emphasized, or both, relative to the sound 170. In particular implementations, the device 100 includes, is included within, or corresponds to a wearable device. In such implementations, a user can wear the device 100 on, over, or near one or both of the user's ears to improve perception of the target sounds, to decrease perception of the non-target sounds, or both. For example, the user can wear the device 100 to improve perception of speech in a noisy environment.

In FIG. 1, the processor(s) 190 are configured to perform operations associated with two data paths, including a first data path 110 and a second data path 120. The first data path 110 is a low-latency data path. To reduce delay, the first data path 110 is configured to perform operations on the audio data 106 in the time domain. Accordingly, delays associated with domain transform operations are avoided in the first data path 110. In contrast, the second data path 120 is configured to provide high-quality noise suppression at the cost of greater latency than the first data path 110. For example, in some implementations, the first data path 110 is associated with latency of 1 millisecond or less, and the second data path 120 is associated with latency of more than 1 millisecond. As another example, in some implementations, the first data path 110 may be associated with latency of 2 milliseconds or less, and the second data path 120 is associated with latency of more than 10 milliseconds.

The second data path 120 is configured to determine time-domain filter coefficients 132, which in some implementations, are stored in a buffer 140 to be subsequently applied by one or more time-domain filters 112 in the first data path 110. In FIG. 1, the second data path 120 includes an analysis filter bank 122, one or more machine-learning models 126, and a time-domain filter designer 130. The buffer 140 can be included in the time-domain filter designer 130, in the time-domain filter(s) 112, or distinct from both the time-domain filter designer 130 and the time-domain filter(s) 112.

The analysis filter bank 122 is configured to perform one or more transform operations (e.g., fast-Fourier transforms (FFT) operations), based on samples of the audio data 106, to generate frequency-domain audio data 124. According to some implementations, a set of samples of the audio data 106 are accumulated for processing by the analysis filter bank 122 (e.g., at one or more buffers of the analysis filter bank 122), and the frequency-domain audio data 124 for the set of samples includes information indicating the magnitude of sound within each frequency bin of a plurality of frequency bins. During or after transformation of the set of samples into the frequency domain, a subsequent set of samples of the audio data 106 is accumulated to be transformed into a subsequent set of frequency-domain audio data 124.

The machine-learning model(s) 126 include one or more trained models, such as neural network(s) that are configured to process input data 125 based on the frequency-domain audio data 124 to generate output data 129. In particular implementations, the machine-learning model(s) 126 are temporally dynamic such that the output data 129 that is based on a particular set of input data 125 is affected by one or more prior sets of input data 125. For example, the machine-learning model(s) 126 can include one or more recurrent neural networks, such as neural network(s) including one or more long-short term memory layers, one or more gated recurrent units, or other recurrent structures.

The time-domain filter designer 130 is configured to process noise-suppression output 128 that is based on the output data 129 to generate the time-domain filter coefficients 132. As an example, the time-domain filter designer 130 can perform one or more reverse transform operations using the noise-suppression output 128 to generate the time-domain filter coefficients 132. The time-domain filter designer 130 can be configured to generate the time-domain filter coefficients 132 as real-valued masks or as complex-valued masks. Examples of real-valued masks that can be generated by the time-domain filter designer 130 in some implementations include linear phase finite impulse response (FIR) filter coefficients, minimum phase FIR filter coefficients, autoregressive filter coefficients, infinite impulse response (IIR) filter coefficients, all-pole filter coefficients, etc. Complex-valued masks can include FIR or IIR filters indicating magnitude and phase. A technical benefit of using linear phase FIR filter coefficients is predictable delay because the delay associated with applying the linear phase FIR filter coefficients is entirely dependent on the length of the FIR filter. A technical benefit of using minimum phase FIR filter coefficients or autoregressive filter coefficients is decreased delay because, while the delay introduced by application of such filter coefficients is frequency dependent, the delay is the minimum possible for the particular input data.

The time-domain filter(s) 112 are updated periodically or occasionally (e.g., when updated time-domain filter coefficients 132 become available). In this arrangement, the time-domain filter(s) 112 apply time-domain filter coefficients 132 to the audio data 106 that is newer than the audio data 106 used to generate the time-domain filter coefficients 132. For example, the audio data 106 can include a first segment (e.g., a portion of the audio data for a particular time period) and a second segment (e.g., a portion of the audio data for a later time period) that is subsequent to (e.g., either immediately following in time, or following one or more other segments that immediately follow) the first segment. In this example, the time-domain filter coefficients 132 can be determined using the first segment and can be applied to the second segment. As one non-limiting example, the operations of the second data path 120 may be performed over a period of about 16 milliseconds; whereas the operations of the first data path 110 may be performed over a period of about 1 millisecond. Thus, in this specific example, the time-domain filter coefficients 132 applied to a particular data sample in the first data path 110 are always at least 16 milliseconds older than the data sample. Except in unusual circumstances, ambient noise typically changes slowly enough that even with such a delay, the time-domain filter coefficients 132 are sufficiently representative to provide significant noise suppression.

During operation, the microphone(s) 102 generate the audio signal(s) 104 based on the sound 170. The sound 170 can include speech or other target sounds as well as non-target sounds, such as noise. The audio data 106 representing the audio signal(s) 104 is provided to the first data path 110 for low-latency processing, and to the second data path 120 to update the time-domain filter coefficients 132.

In the first data path 110, the audio data 106 is processed by the time-domain filter(s) 112 applying a first set of time-domain filter coefficients 132 to the audio data 106. The first set of time-domain filter coefficients 132 are received from the second data path 120 after processing of a prior set of audio data 106. The time-domain filter(s) 112 generate the noise-suppressed output signal 114 by applying the first set of time-domain filter coefficients 132 to the audio data 106. The noise-suppressed output signal 114 is provided to (e.g., is used to drive) the speaker 108 to generate the output sound 172. Optionally, the processor(s) 190 can perform other processing on the noise-suppressed output signal 114 before providing the noise-suppressed output signal 114 to the speaker 108. For example, the processor(s) 190 can perform feedforward adaptive noise cancellation (ANC), feedback ANC, or hybrid ANC to further process the noise-suppressed output signal 114.

In the second data path 120, a set of samples of the audio data 106 are accumulated and subjected to one or more transform operations by the analysis filter bank 122 to generate the frequency-domain audio data 124 representing the set of samples. In some implementations, the frequency-domain audio data 124 is provided as input (e.g., as the input data 125) to the machine-learning model(s) 126. In other implementations, the frequency-domain audio data 124 is processed to generate the input data 125. For example, the frequency-domain audio data 124 can optionally be subjected to a variety of frequency-domain noise suppression or signal augmentation operations to generate the input data 125. To illustrate, the input data 125 can be generated by subjecting the frequency-domain audio data 124 to beamforming operations, blind source separation operations, speech augmentation operations, or combinations thereof. Performing such conventional frequency-domain operations to generate the input data 125 can improve operation of the machine-learning model(s) 126 by providing cleaner input data 125. In the same or different implementations, generating the input data 125 based on the frequency-domain audio data 124 can include data aggregation operations, filtering operations, resampling operations, etc.

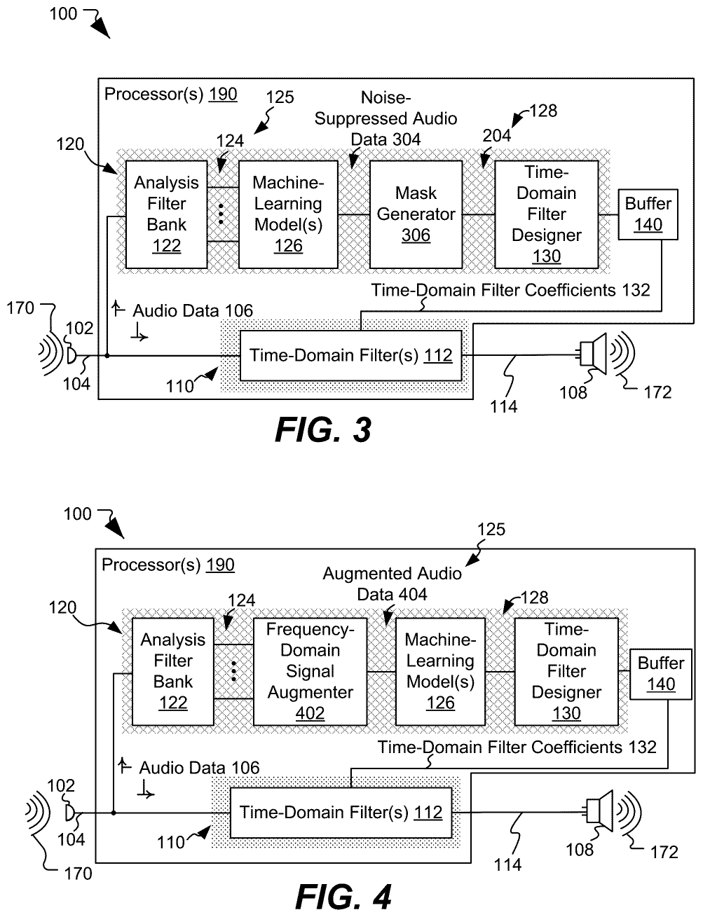

The machine-learning model(s) 126 perform non-linear, temporally dynamic operations, based on prior training of the machine-learning model(s) 126 to generate the output data 129. In some implementations, the machine-learning model(s) 126 are trained to generate output data 129 that includes target audio components of the frequency-domain audio data 124 and omits or suppresses non-target audio components of the frequency-domain audio data 124. Such models are referred to herein as “inline” models. In contrast, in some implementations, the machine-learning model(s) 126 are trained to generate output data 129 that includes the non-target audio components of the frequency-domain audio data 124 and omits or suppresses the target audio components of the frequency-domain audio data 124. Such models are referred to herein as “masking” models. Output data 129 from masking models can be used directly as the noise-suppression output 128. Output data 129 from inline models may be further processed to generate the noise-suppression output 128, as described further with reference to FIG. 3.

The noise-suppression output 128 represents an estimate (by the machine-learning model(s) 126) of a portion of (e.g., audio components of) the frequency-domain audio data 124 that correspond to non-target audio (e.g., noise). The noise-suppression output 128 is provided as input to the time-domain filter designer 130. The time-domain filter designer 130 performs inverse transform operations and parameterization operations to generate the time-domain filter coefficients 132. The specific inverse transform operations and parameterization operations performed can be different for different implementations. As an example, the inverse transform operations can include various inverse Fourier transform operations, such as inverse fast-Fourier transform (IFFT) operations. The parametrization operations can include, for example, windowing or shifting time-domain data generated by the inverse transform operations to generate a specific number of time-domain filter coefficients 132 based, for example, on a number of filter coefficients applied by the time-domain filter(s) 112. Applying a larger number of filter coefficients can provide greater noise suppression at the cost of greater computational complexity.

While time-domain filter coefficients 132 based on a first set of samples of the audio data 106 are being generated, additional samples of the audio data 106 can be received and aggregated to form a second set of samples of the audio data. After the second set of samples is collected, the second set of samples is subjected to the same operations described above to generate a second set of time-domain filter coefficients 132. In some implementations, the second set of samples is independent of the first set of samples. For example, there is no overlap between the first and second sets of samples. In other implementations, the second set of samples includes one or more samples of the first set of samples. That is, the first and second sets of samples have at least some overlap. The specific amount of overlap is different for different implementations and can be selected based on available processing resources, a specific sound environment, user settings, or other selection criteria.

In the example illustrated in FIG. 1, the audio data 106 provided to the first data path 110 is the same as the audio data 106 provided to the second data path 120. In some implementations, the audio data 106 provided to the second data path 120 includes the audio data 106 provided to the first data path 110 as well as additional audio data 106. For example, the device 100 may include two or more microphones 102, and at least one of the microphones 102 is coupled to the second data path 120 and not to the first data path 110. To illustrate, the device 100 may include a self-talk microphone that is configured primarily to capture sound corresponding to speech of a user of the device 100. In this illustrative example, the audio data 106 generated by the self-talk microphone can be provided to the second data path 120 to generate time-domain filter coefficients 132, and not provided to the first data path 110 to generate the noise-suppressed output signal 114.

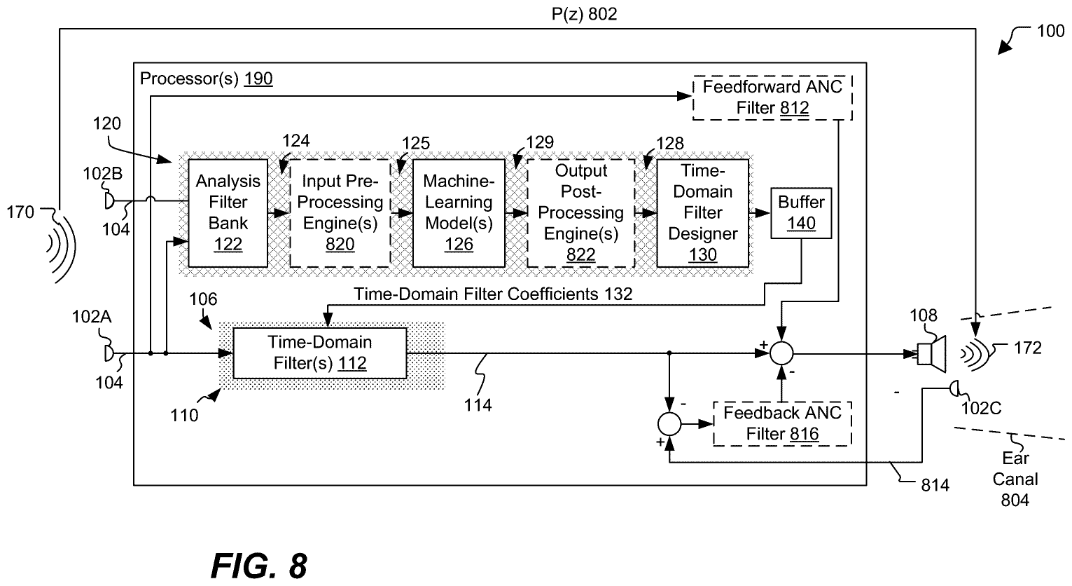

Additionally, or alternatively, in some implementations, the audio data 106 provided to the first data path 110 includes the audio data 106 provided to the second data path 120 as well as additional audio data 106. For example, the device 100 may include two or more microphones 102, and at least one of the microphones 102 is coupled to the first data path 110 and not to the second data path 120. To illustrate, the device 100 may include a feedback microphone that is configured primarily to capture the output sound 172 and to generate a feedback signal. In this illustrative example, the audio data 106 generated by the feedback microphone can be processed in the time-domain (e.g., at a feedback ANC filter 816, shown in FIG. 8) to generate or modify the noise-suppressed output signal 114.

Additionally, or alternatively, in some implementations, the audio data 106 provided to the first data path 110 includes at least some of the audio data 106 provided to the second data path 120, the audio data 106 provided to the second data path 120 includes at least some of the audio data 106 provided to the first data path 110, and each of the data paths 110, 120 is also provided additional audio data 106 that is not provided to the other data path 110, 120. For example, the device 100 may include both the feedback microphone and the self-talk microphone, each of which operate as described above.

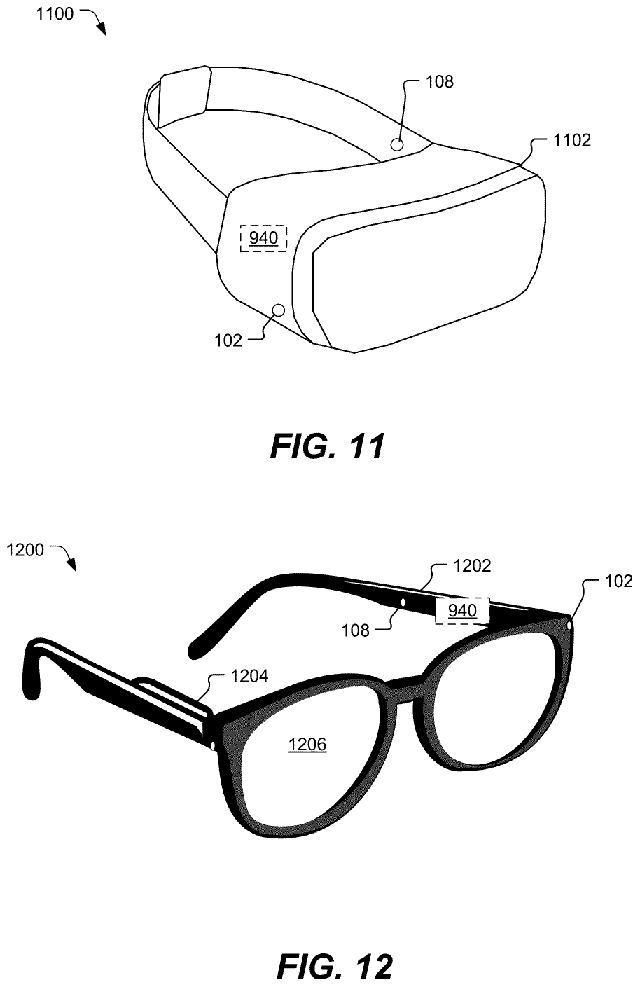

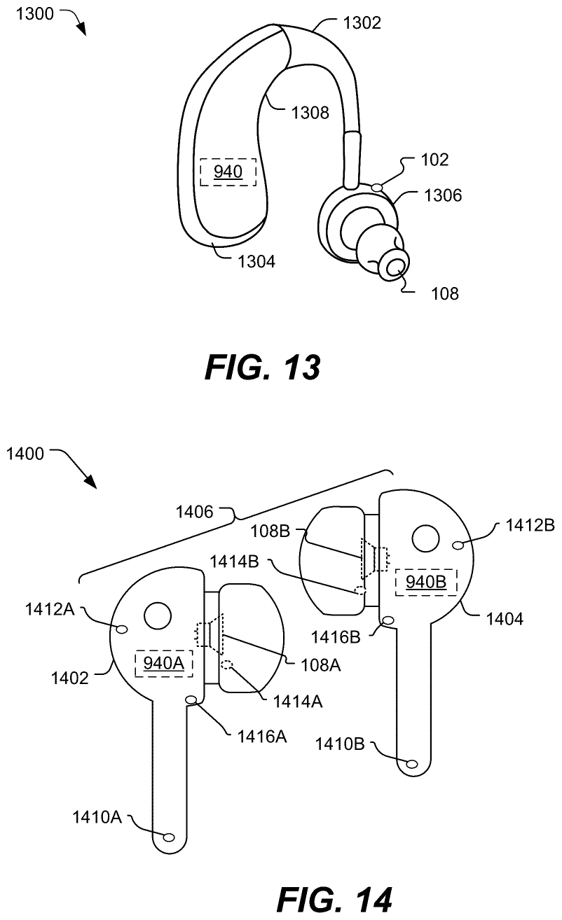

In some implementations, the device 100 corresponds to or is included in one of various types of devices. In an illustrative example, the processor 190 is integrated in a wearable device that includes or is coupled to the microphone(s) 102 and the speaker(s) 108. Examples of such wearable devices include, without limitation, a headset device as described further with reference to FIG. 10; a virtual reality, mixed reality, or augmented reality headset as described with reference to FIG. 11; augmented reality glasses as described with reference to FIG. 12; a hearing aid device as described with reference to FIG. 13; or earbuds as described with reference to FIG. 14.

One technical advantage of implementing the device 100 as described above is that the device 100 can provide high-quality noise suppression without introducing undue latency. For example, noise suppression for incoming audio data 106 is entirely performed in the time domain (e.g., by the first data path 110) thereby avoiding delays due to domain transform and inverse transform operations. Thus, the latency introduced by the noise suppression operations is very small (e.g., on the order of 2 milliseconds or less) and is comparable to the latency of conventional time-domain noise suppression operations, such as ANC. However, the quality of the noise suppression is greater than can be achieved using such conventional time-domain noise suppression operations.

FIG. 2 is a block diagram of illustrative aspects of the device of FIG. 1, which is operable to perform low-latency noise suppression, in accordance with some examples of the present disclosure. The device 100 of FIG. 2 represents one particular, non-limiting, example of the device 100 of FIG. 1, as such, the device 100 of FIG. 2 includes many of the same components as illustrated in FIG. 1, each of which operates as described above. For example, the device 100 of FIG. 2 includes the first data path 110 and the second data path 120. As described with reference to FIG. 1, the first data path 110 includes the time-domain filter(s) 112 which are configured to apply time-domain filter coefficients 132 (that are determined in the second data path 120) to audio data 106 to generate the noise-suppressed output signal 114.

In the example illustrated in FIG. 2, the second data path 120 includes the analysis filter bank 122, the machine-learning model(s) 126, and the time-domain filter designer 130. In some implementations, the processor(s) 190 of FIG. 2 also include the buffer 140 between the time-domain filter designer 130 and the time-domain filter(s) 112. In FIG. 2, the machine-learning model(s) 126 are configured to receive input data 125 that includes or is based on the frequency-domain audio data 124 and to generate as output data 129 a frequency mask 204. The frequency mask 204 represents an estimated magnitude of noise in the frequency-domain audio data 124 for each frequency bin of a plurality of frequency bins. Since the frequency mask 204 is a frequency-domain estimate of noise in the audio data 106, the frequency mask 204 can be provided as input to the time-domain filter designer 130 to generate the time-domain filter coefficients 132.

FIG. 3 is a block diagram of illustrative aspects of the device of FIG. 1, which is operable to perform low-latency noise suppression, in accordance with some examples of the present disclosure. The device 100 of FIG. 3 represents one particular, non-limiting, example of the device 100 of FIG. 1, as such, the device 100 of FIG. 3 includes many of the same components as illustrated in FIG. 1, each of which operates as described above. For example, the device 100 of FIG. 3 includes the first data path 110 and the second data path 120. As described with reference to FIG. 1, the first data path 110 includes the time-domain filter(s) 112 which are configured to apply time-domain filter coefficients 132 (that are determined in the second data path 120) to audio data 106 to generate the noise-suppressed output signal 114.

In the example illustrated in FIG. 3, the second data path 120 includes the analysis filter bank 122, the machine-learning model(s) 126, and the time-domain filter designer 130. In some implementations, the processor(s) 190 of FIG. 3 also include the buffer 140 between the time-domain filter designer 130 and the time-domain filter(s) 112. In FIG. 3, the machine-learning model(s) 126 are configured to receive input data 125 that includes or is based on the frequency-domain audio data 124 and to generate noise-suppressed audio data 304 as the output data 129 of FIG. 1. The noise-suppressed audio data 304 includes, for example, a frequency-domain estimate of target audio in the audio data 106. In some embodiments, the noise-suppressed audio data 304 can include synthesized audio data. For example, the machine-learning model(s) 126 can be configured to synthesize target audio (e.g., speech) based on the input data 125. An advantage of the machine-learning model(s) 126 generating synthesized target audio (e.g., speech) is that the synthesized target audio can be devoid of non-target audio; thus, the noise-suppressed audio data 304 in this example can include only target audio.

In FIG. 3, the second data path 120 also includes a mask generator 306. The mask generator 306 is configured to generate the frequency mask 204 based on the noise-suppressed audio data 304. For example, the mask generator 306 can determine, for each frequency bin of a set of frequency bins, a ratio of the noise-suppressed audio data 304 to the frequency-domain audio data 124. Each frequency bin of the frequency-domain audio data 124 can be adjusted by a ratio associated with the frequency bin to generate the frequency mask 204. The frequency mask 204 can be included in or correspond to the noise-suppression output 128 that is provided as input to the time-domain filter designer 130 to generate the time-domain filter coefficients 132.

FIG. 4 is a block diagram of illustrative aspects of the device of FIG. 1, which is operable to perform low-latency noise suppression, in accordance with some examples of the present disclosure. The device 100 of FIG. 4 represents one particular, non-limiting, example of the device 100 of FIG. 1, as such, the device 100 of FIG. 4 includes many of the same components as illustrated in FIG. 1, each of which operates as described above. For example, the device 100 of FIG. 4 includes the first data path 110 and the second data path 120. As described with reference to FIG. 1, the first data path 110 includes the time-domain filter(s) 112 which are configured to apply time-domain filter coefficients 132 (that are determined in the second data path 120) to audio data 106 to generate the noise-suppressed output signal 114.

In the example illustrated in FIG. 4, the second data path 120 includes the analysis filter bank 122, a frequency-domain signal augmenter 402, the machine-learning model(s) 126, and the time-domain filter designer 130. In some implementations, the processor(s) 190 of FIG. 4 also include the buffer 140 between the time-domain filter designer 130 and the time-domain filter(s) 112. The frequency-domain signal augmenter 402 is configured to process the frequency-domain audio data 124 to generate augmented audio data 404. The augmented audio data 404 has an improved signal to noise ratio (SNR) relative to the frequency-domain audio data 124. The frequency-domain signal augmenter 402 can use one or more of a variety of different operations to improve the SNR. Examples of such operations are described with reference to FIGS. 5-7.

In FIG. 4, the input data 125 includes or is based on the augmented audio data 404. The machine-learning model(s) 126 of FIG. 4 generate output data 129, such as a frequency mask, noise-suppressed audio data, or both, based on the input data 125. The time-domain filter designer 130 generates the time-domain filter coefficients 132 based on a noise-suppression output 128 that includes or is based on the output data 129. To illustrate, in some examples in which the output data 129 of the machine-learning model(s) 126 of FIG. 4 is a frequency mask, the noise-suppression output 128 includes or corresponds to the output data 129. In other examples in which the output data 129 of the machine-learning model(s) 126 of FIG. 4 is noise-suppressed audio data, the second path 120 can further include the mask generator 306 of FIG. 3 to generate a frequency mask that corresponds to or is included in the noise-suppression output 128.

FIG. 5 is a block diagram of illustrative aspects of the device of FIG. 1, which is operable to perform low-latency noise suppression, in accordance with some examples of the present disclosure. The device 100 of FIG. 5 represents one particular, non-limiting, example of the device 100 of FIG. 1, as such, the device 100 of FIG. 5 includes many of the same components as illustrated in FIG. 1, each of which operates as described above. For example, the device 100 of FIG. 5 includes the first data path 110 and the second data path 120. As described with reference to FIG. 1, the first data path 110 includes the time-domain filter(s) 112 which are configured to apply time-domain filter coefficients 132 that are determined in the second data path 120 to audio data 106 to generate the noise-suppressed output signal 114.

In the example illustrated in FIG. 5, the second data path 120 includes the analysis filter bank 122, a beamformer 502, the machine-learning model(s) 126, and the time-domain filter designer 130. In some implementations, the processor(s) 190 of FIG. 5 also include the buffer 140 between the time-domain filter designer 130 and the time-domain filter(s) 112. The beamformer 502 is one example of the frequency-domain signal augmenter 402 of FIG. 4. The beamformer 502 is configured to process the frequency-domain audio data 124 to emphasize or de-emphasize sound received from a particular direction to generate beamformed audio data 504. For example, components of the sound 170 originating from the direction of a target sound source can be emphasized in the beamformed audio data 504, components of the sound 170 originating from a direction other than the direction of a target sound source can be de-emphasized in the beamformed audio data 504, or both.

Audio signals 104 from two or more microphones 102 (e.g., a first microphone 102A and a second microphone 102B) are used to determine directionality associated with the sound 170. Optionally, in some implementations, other information can be used to determine the direction to the target sound source. For example, a camera can be used to generate image data or video data that can be analyzed to determine a direction from the device 100 of FIG. 5 to a person who is speaking. In other examples, no other sensors are used. To illustrate, the beamformer 502 can direct a beam toward the dominant sound source in a particular environment on the assumption that the dominant sound source is more likely to be the target sound source than is a background sound source.

In FIG. 5, the input data 125 includes or is based on the beamformed audio data 504. Since the beamformed audio data 504 represents an improvement of the SNR of the target sound, computational complexity of the machine-learning model(s) 126 of FIG. 5 can be reduced relative to generating the input data 125 based on the frequency-domain audio data 124 without beamforming. The machine-learning model(s) 126 generate output data 129, such as a frequency mask, noise-suppressed audio data, or both, based on the input data 125. The time-domain filter designer 130 generates the time-domain filter coefficients 132 based on a noise-suppression output 128 that includes or is based on the output data 129.

FIG. 6 is a block diagram of illustrative aspects of the device of FIG. 1, which is operable to perform low-latency noise suppression, in accordance with some examples of the present disclosure. The device 100 of FIG. 6 represents one particular, non-limiting, example of the device 100 of FIG. 1, as such, the device 100 of FIG. 6 includes many of the same components as illustrated in FIG. 1, each of which operates as described above. For example, the device 100 of FIG. 6 includes the first data path 110 and the second data path 120. As described with reference to FIG. 1, the first data path 110 includes the time-domain filter(s) 112 which are configured to apply time-domain filter coefficients 132 that are determined in the second data path 120 to audio data 106 to generate the noise-suppressed output signal 114.

In the example illustrated in FIG. 6, the second data path 120 includes the analysis filter bank 122, a speech augmentation engine 602, the machine-learning model(s) 126, and the time-domain filter designer 130. In some implementations, the processor(s) 190 of FIG. 6 also include the buffer 140 between the time-domain filter designer 130 and the time-domain filter(s) 112. The speech augmentation engine 602 is one example of the frequency-domain signal augmenter 402 of FIG. 4. The speech augmentation engine 602 is configured to process the frequency-domain audio data 124 to emphasize components of the frequency-domain audio data 124 that represent speech to generate speech-augmented audio data 604. For example, speech augmentation engine 602 can perform spectral modification, such as filtering, equalization, and spectral enhancement, to emphasize speech, to de-emphasize non-speech, or both.

In FIG. 6, the input data 125 includes or is based on the speech-augmented audio data 604. Since the speech-augmented audio data 604 represents an improvement of the SNR of the target sound when the target sound is speech, computational complexity of the machine-learning model(s) 126 of FIG. 6 can be reduced relative to generating the input data 125 based on the frequency-domain audio data 124 without speech augmentation. The machine-learning model(s) 126 generate output data 129, such as a frequency mask, noise-suppressed audio data, or both, based on the input data 125. The time-domain filter designer 130 generates the time-domain filter coefficients 132 based on a noise-suppression output 128 that includes or is based on the output data 129.

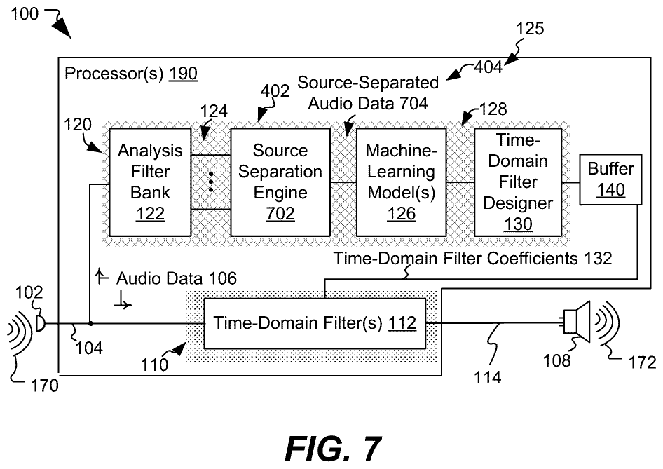

FIG. 7 is a block diagram of illustrative aspects of the device of FIG. 1, which is operable to perform low-latency noise suppression, in accordance with some examples of the present disclosure. The device 100 of FIG. 7 represents one particular, non-limiting, example of the device 100 of FIG. 1, as such, the device 100 of FIG. 7 includes many of the same components as illustrated in FIG. 1, each of which operates as described above. For example, the device 100 of FIG. 7 includes the first data path 110 and the second data path 120. As described with reference to FIG. 1, the first data path 110 includes the time-domain filter(s) 112 which are configured to apply time-domain filter coefficients 132 that are determined in the second data path 120 to audio data 106 to generate the noise-suppressed output signal 114.

In the example illustrated in FIG. 7, the second data path 120 includes the analysis filter bank 122, a source separation engine 702, the machine-learning model(s) 126, and the time-domain filter designer 130. In some implementations, the processor(s) 190 of FIG. 7 also include the buffer 140 between the time-domain filter designer 130 and the time-domain filter(s) 112. The source separation engine 702 is one example of the frequency-domain signal augmenter 402 of FIG. 4. The source separation engine 702 is configured to process the frequency-domain audio data 124 to identify and emphasize components of the frequency-domain audio data 124 that represent sound 170 from a target source. For example, source separation engine 702 can use blind source separation operations, such as independent component analysis, to perform the source separation. In this example, a portion of the source-separated audio data that corresponds to a target sound can be used to generate the input data 125.

In FIG. 7, the input data 125 includes or is based on the source-separated audio data 704. Since the source-separated audio data 704 represents an improvement of the SNR of the target sound, computational complexity of the machine-learning model(s) 126 of FIG. 7 can be reduced relative to generating the input data 125 based on the frequency-domain audio data 124 without source separation. The machine-learning model(s) 126 generate output data 129, such as a frequency mask, noise-suppressed audio data, or both, based on the input data 125. The time-domain filter designer 130 generates the time-domain filter coefficients 132 based on a noise-suppression output 128 that includes or is based on the output data 129.

Although FIGS. 5-7 illustrate implementations of the device 100 in which particular examples of signal augmentation are performed, in some implementations, the frequency-domain signal augmenter 402 can perform more than one of these signal augmentation operations or other frequency-domain signal augmentation operations. For example, the frequency-domain signal augmenter 402 can include the beamformer 502 and the speech augmentation engine 602. As another example, the frequency-domain signal augmenter 402 can include the beamformer 502 and the source separation engine 702. As another example, the frequency-domain signal augmenter 402 can include the speech augmentation engine 602 and the source separation engine 702. In still another example, the frequency-domain signal augmenter 402 can include the beamformer 502, the speech augmentation engine 602, and the source separation engine 702.

FIG. 8 is a block diagram of illustrative aspects of the device of FIG. 1, which is operable to perform low-latency noise suppression, in accordance with some examples of the present disclosure. The device 100 of FIG. 8 represents one particular, non-limiting, example of the device 100 of FIG. 1, as such, the device 100 of FIG. 8 includes many of the same components as illustrated in FIG. 1, each of which operates as described above. For example, the device 100 of FIG. 8 includes the first data path 110 and the second data path 120. As described with reference to FIG. 1, the first data path 110 includes the time-domain filter(s) 112 which are configured to apply time-domain filter coefficients 132 that are determined in the second data path 120 to audio data 106 to generate the noise-suppressed output signal 114.

In the example illustrated in FIG. 8, the second data path 120 includes the analysis filter bank 122, the machine-learning model(s) 126, and the time-domain filter designer 130. In some implementations, the processor(s) 190 of FIG. 8 also include the buffer 140 between the time-domain filter designer 130 and the time-domain filter(s) 112. In various implementations, the second data path 120 also optionally includes one or more input pre-processing engines 820, one or more output post-processing engines 822, or both.

As described above, the analysis filter bank 122 is configured to receive the audio data 106 representing the audio signals 104 from the one or more microphones 102 (e.g., microphones 102A and 102B in FIG. 8) and to generate the frequency-domain audio data 124. In some implementations, the frequency-domain audio data 124 is used as the input data 125 for the machine-learning model(s) 126. In such implementations, the input pre-processing engine(s) 820 can be omitted. In other implementations, the frequency-domain audio data 124 is modified to generate the input data 125 for the machine-learning model(s) 126. In such implementations, the input pre-processing engine(s) 820 are configured to generate the input data 125 based on the frequency-domain audio data 124. For example, the input pre-processing engine(s) 820 can include one or more frequency-domain signal augmenters (e.g., the frequency-domain signal augmenters 402 of FIG. 4), such as the beamformer 502 of FIG. 5, the speech augmentation engine 602 of FIG. 6, the source separation engine 702 of FIG. 7, or combinations thereof. The input pre-processing engine(s) 820 can also, or alternatively, perform other operations to generate the input data 125 based on the frequency-domain audio data 124. For example, the input pre-processing engine(s) 820 can perform data aggregation operations, filtering operations, resampling operations, other data manipulations, or combinations thereof, to generate the input data 125.

The machine-learning model(s) 126 generate the output data 129 based on the input data 125. Depending on the configuration of the machine-learning model(s) 126, the output data 129 can include noise-suppressed audio data, a frequency mask, or both. Optionally, the output data 129 can be modified by the output post-processing engine(s) 822 to generate the noise-suppression output 128 that is provided to the time-domain filter designer 130 to generate the time-domain filter coefficients 132. For example, when the output data 129 includes noise-suppressed audio data, the output post-processing engine(s) 822 can perform operations to determine a frequency mask based on the noise-suppressed audio data, such as described for the mask generator 306 of FIG. 3. The output post-processing engine(s) 822 can also, or alternatively, perform other operations to generate the noise-suppression output 128 based on the output data 129. For example, the output post-processing engine(s) 822 can perform data aggregation operations, filtering operations, resampling operations, other data manipulations, or combinations thereof, to generate the noise-suppression output 128.

FIG. 8 illustrates a number of optional components, some or all of which are included in some implementations and omitted in other implementations. For example, in FIG. 8, the processor(s) 190 include a feedforward ANC filter 812 configured to perform feedforward adaptive noise cancellation based on the audio data 106 from one or more of the microphone(s) 102. As another example, in FIG. 8, the device 100 includes or is coupled to at least one external microphone (e.g., the microphones 102A and 102B) configured to generate the audio data 106 representing the sound 170 in the ambient environment around the device 100. Additionally, in FIG. 8, the device 100 includes or is coupled to at least one feedback microphone (e.g., microphone 102C) configured to generate a feedback signal 814 based on sound present near the speaker(s) 108, which may include the output sound 172 produced by the speaker(s) 108 and components of the sound 170 conveyed directly to an car canal 804 of a user (subject to some transfer function P(z) 802). In this example, the feedback signal 814 can be provided to a feedback ANC filter 816 to generate a feedback noise signal that is subtracted from the noise-suppressed output signal 114.

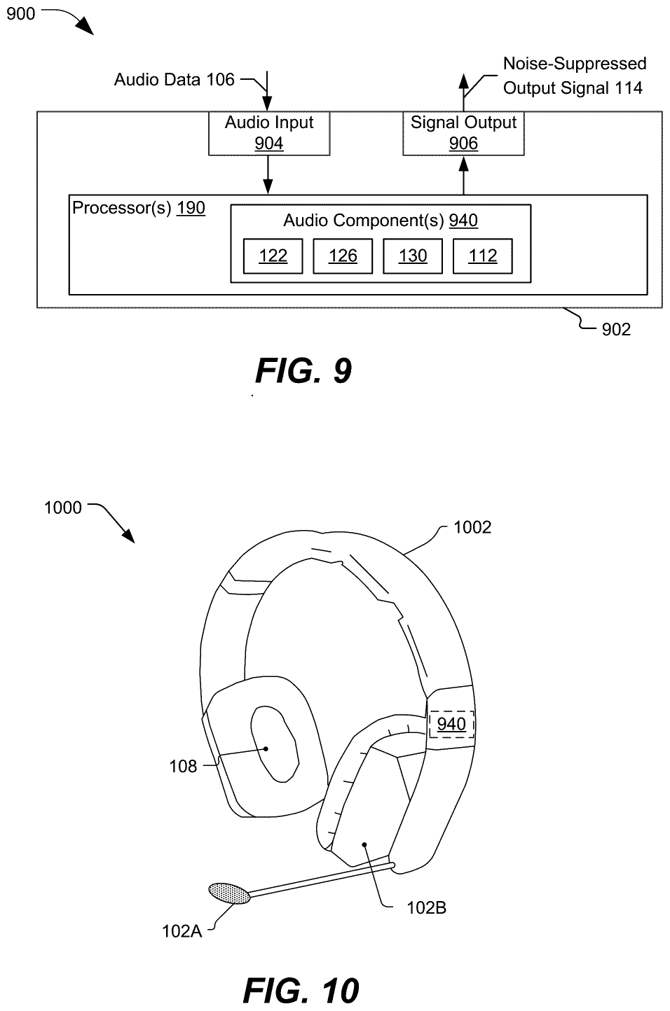

FIG. 9 depicts an implementation 900 of the device 100 as an integrated circuit 902 that includes the one or more processors 190. The integrated circuit 902 also includes an audio input 904, such as one or more bus interfaces, to enable the audio data 106 to be received for processing. The integrated circuit 902 also includes a signal output 906, such as a bus interface, to enable sending of the noise-suppressed output signal 114. In FIG. 9, the processor(s) 190 of the integrated circuit 902 include one or more audio components 940, such as the analysis filter bank 122, the machine-learning model(s) 126, the time-domain filter designer 130, and the time-domain filter(s) 112. Optionally, the audio component(s) 940 can include other components as described above with reference to FIGS. 1-8, such as the mask generator 306 of FIG. 3; the frequency-domain signal augmenter 402 of any of FIGS. 4-7; or any one or more of the input pre-processing engine(s) 820, the output post-processing engine(s) 822, the feedforward ANC filter 812, and the feedback ANC filter 816 of FIG. 8. The integrated circuit 902 enables implementation of high-quality, low-latency noise suppression as a component in a system, such as a wearable device that includes microphones, such as the headset as depicted in FIG. 10, a virtual reality, mixed reality, or augmented reality headset as depicted in FIG. 11, augmented reality headset glasses as depicted in FIG. 12, a wearable device as depicted in FIG. 13, earbuds as depicted in FIG. 14, or another wearable device.

FIG. 10 depicts an implementation 1000 in which the device 100 includes a headset device 1002. The headset device 1002 includes the microphone(s) 102 and the speaker(s) 108. In the example illustrated in FIG. 10, the microphone 102A is positioned primarily to detect speech from a person wearing the headset device 1002, and the microphone 102B is positioned to detect ambient sound, such as speech from another person or other sounds. Components of the processor(s) 190, including the audio component 940, are integrated in the headset device 1002 and depicted using dashed lines to indicate components not generally visible to a user of the headset device 1002.

In a particular example of operation, the microphone 102B can detect sound in an environment around the headset device 1002 and generate audio data representing the sound. The audio data can be provided to the audio components 940, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to received audio data in the time domain, little or no latency is added by using such time-domain filter coefficients to process the audio data. Thus, the headset device 1002 can provide high-quality, low-latency noise suppression.

FIG. 11 depicts an implementation 1100 in which the device 100 includes a portable electronic device that corresponds to a virtual reality, mixed reality, or augmented reality headset device 1102. The headset device 1102 includes the microphone(s) 102 and the speaker(s) 108. Additionally, components of the processor(s) 190, including the audio component 940, are integrated in the headset device 1102. In a particular example of operation, the microphone(s) 102 can detect sound in an environment around the headset device 1102 and generate audio data representing the sound. The audio data can be provided to the audio components 940, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the headset device 1102 can provide high-quality, low-latency noise suppression.

FIG. 12 depicts an implementation 1200 in which the device 100 includes a portable electronic device that corresponds to augmented reality or mixed reality glasses 1202. The glasses 1202 include a holographic projection unit 1204 configured to project visual data onto a surface of a lens 1206 or to reflect the visual data off of a surface of the lens 1206 and onto the wearer's retina. The glasses 1202 also include the microphone(s) 102, the speaker(s) 108, and the processor(s) 190, which include the audio component 940.

In a particular example of operation, the microphone(s) 102 can detect sound in an environment around the glasses 1202 and generate audio data representing the sound. The audio data can be provided to the audio components 940, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the glasses 1202 can provide high-quality, low-latency noise suppression.

In some implementations, the holographic projection unit 1204 is configured to display information related to the sound detected by the microphone(s) 102. For example, the holographic projection unit 1204 can display a notification indicating that speech has been detected. In another example, the holographic projection unit 1204 can display a notification indicating a detected audio event. For example, the notification can be superimposed on the user's field of view at a particular position that coincides with the location of the source of the sound associated with the audio event.

FIG. 13 is a diagram of a wearable device operable to perform low-latency noise suppression, in accordance with some examples of the present disclosure. In the example illustrated in FIG. 13, the wearable device is a hearing aid device 1302. The hearing aid device 1302 includes the microphone(s) 102, the speaker(s) 108, and the processor(s) 190, which include the audio component 940. In the example illustrated in FIG. 13, the hearing aid device 1302 includes a portion 1304 configured to be worn behind an ear of the user, a portion 1308 configured to extend over the ear, and a portion 1306 to be worn at or near an ear canal of the user. In other examples, the hearing aid device 1302 has a different configuration or form factor. To illustrate, the hearing aid device 1302 can be an in-ear device that does not include the portion 1304 configured to be worn behind an ear and the portion 1308 configured to extend over the ear.

In a particular example of operation of the hearing aid device 1302, the microphone(s) 102 can detect sound in an environment around the hearing aid device 1302 and generate audio data representing the sound. The audio data can be provided to the audio components 940, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to receive audio data in the time domain, little or no latency is added by using such time-domain filter coefficients to process the audio data. Thus, the hearing aid device 1302 can provide high-quality, low-latency noise suppression.

FIG. 14 depicts an implementation 1400 in which the device 100 includes a portable electronic device that corresponds to one or more earbuds 1406 (e.g., a first earbud 1402, a second earbud 1404, or both). Although earbuds 1406 are described, it should be understood that the present technology can be applied to other in-ear or over-ear audio devices.

In the example illustrated in FIG. 14, the first earbud 1402 includes a first microphone 1410A, such as a high signal-to-noise microphone positioned to capture the voice of a wearer of the first earbud 1402, one or more other microphones configured to detect ambient sounds and spatially distributed to support beamforming, illustrated as microphone(s) 1412A, an “inner” microphone 1414A proximate to the wearer's ear canal (e.g., to assist with active noise cancelling), and a self-speech microphone 1416A, such as a bone conduction microphone configured to convert sound vibrations of the wearer's ear bone or skull into an audio signal. In a particular implementation, the microphone(s) 1412A correspond to the microphone(s) 102 of any of FIG. 1-4, 6 or 7 or correspond to the microphone(s) 102A and/or 102B of FIG. 5 or 8. In a particular implementation, the microphone 1414A corresponds to the microphone 102C of FIG. 8.

The second earbud 1404 can be configured in a substantially similar manner as the first earbud 1402. For example, the second earbud can include a microphone 1410B positioned to capture the voice of a wearer of the second earbud 1404, one or more other microphones 1412B configured to detect ambient sounds and spatially distributed to support beamforming, an “inner” microphone 1414B, and a self-speech microphone 1416B.

In some implementations, the earbuds 1402, 1404 are configured to automatically switch between various operating modes, such as a passthrough mode in which ambient sound is processed, by the audio components 940, for output via a speaker(s) 108, and a playback mode in which non-ambient sound (e.g., streaming audio corresponding to a phone conversation, media playback, video game, etc.) is played back through the speaker(s) 108. In other implementations, the earbuds 1402, 1404 may support fewer modes or may support one or more other modes in place of, or in addition to, the described modes.

In an illustrative example of operation in the passthrough mode, one or more of the microphone(s) 102 (e.g., the microphone(s) 1412A, 1412B) can detect sound in an environment around the earbuds 1402, 1404 and generate audio data representing the sound. The audio data can be provided to one or both of the audio components 940A, 940B, which can process the audio data in the time domain to generate a noise-suppressed output signal and can process the audio data in the frequency domain to generate (or update) time-domain filter coefficients that are applied to subsequently received audio data. In this example, the time-domain filter coefficients determined via frequency-domain processing provide high-quality noise suppression, and since the time-domain filter coefficients are applied to received audio data in the time domain, little or no latency is added by using such time-domain filter coefficients to process the audio data. Thus, the earbuds 1402, 1404 can provide high-quality, low-latency noise suppression.

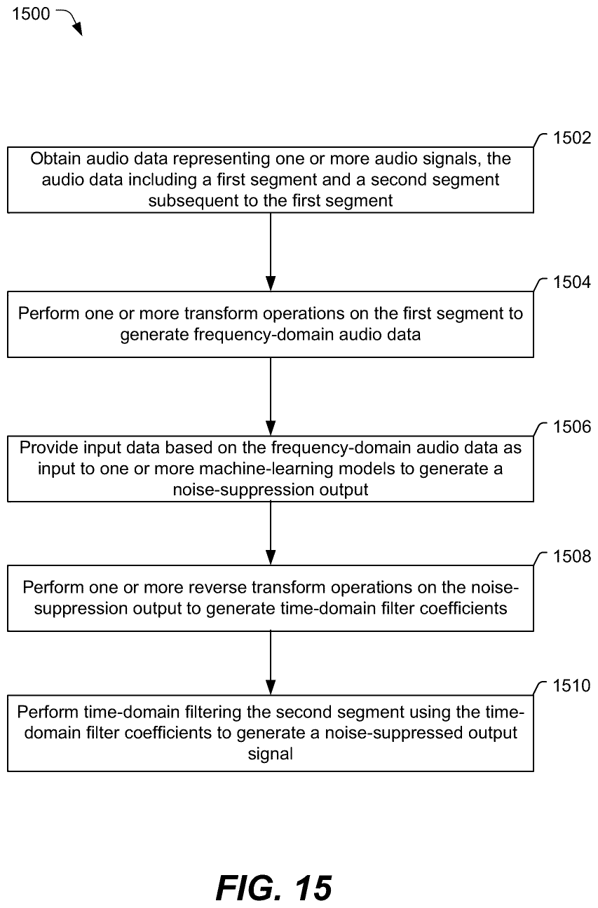

FIG. 15 is a diagram of a particular implementation of a method of performing low-latency noise suppression that may be performed by the device of FIG. 1, in accordance with some examples of the present disclosure. In a particular aspect, one or more operations of the method 1500 are performed by at least one of the device 100, the processor(s) 190, or the audio components 940, variously described with reference to FIGS. 1-14, or a combinations thereof.

The method 1500 includes, at block 1502, obtaining audio data representing one or more audio signals. The audio data includes a first segment and a second segment subsequent to the first segment. For example, referring to FIG. 1, the audio data 106 represents the audio signal(s) 104 received from the microphone(s) 102. In this example, the microphone(s) 102 generate the audio signal(s) 104 based on the sound 170 present in an environment around the device 100. Each of the segments can include a time segment of the audio signal, such as sample representing a few milliseconds of the audio signal.

The method 1500 includes, at block 1504, performing one or more transform operations on the first segment to generate frequency-domain audio data. For example, referring to FIG. 1, the analysis filter bank 122 performs one or more transform operations (e.g., time-domain to frequency domain transformation operations, such as FFT) to generate the frequency-domain audio data 124.

The method 1500 includes, at block 1506, providing input data based on the frequency-domain audio data as input to one or more machine-learning models to generate a noise-suppression output. For example, in some implementations, the input data includes or corresponds to the frequency-domain audio data. In other implementations, the frequency-domain audio data is modified or manipulated to generate the input data. For example, in some such implementations, the method 1500 includes performing beamforming operations to determine beamformed audio data that distinguishes a portion of the audio data from a target audio source and a portion of the audio data from a non-target audio source. In this example, the input data is based on (e.g., includes or corresponds to) the beamformed audio data. As another example, in some such implementations, the method 1500 includes performing speech augmentation operations to determine speech-augmented audio data. In this example, the input data is based on (e.g., includes or corresponds to) the speech-augmented audio data. As another example, in some such implementations, the method 1500 includes performing source separation operations to determine source-separated audio data. In this example, the input data is based on (e.g., includes or corresponds to) the source-separated audio data. In addition to, or instead of, performing signal augmentation operations (such as beamforming, speech augmentation, or source separation), the method 1500 can include performing other data manipulations to generate the input data based on the frequency-domain audio data, such as data aggregation, filtering, etc.

In some implementations, the one or more machine-learning models directly generate the noise-suppression output (e.g., the noise-suppression output is the output data from the one or more machine-learning models). For example, masking machine-learning models output a frequency mask that can be used as or included in the noise-suppression output.

In some implementations, the one or more machine-learning models generate the output data that is modified to generate the noise-suppression output. For example, inline machine-learning models output noise-suppressed audio data. In this example, a mask generator (e.g., the mask generator 306 of FIG. 3) can generate a frequency mask based on the noise-suppressed audio data and the frequency-domain audio data.

The method 1500 includes, at block 1508, performing one or more reverse transform operations on the noise-suppression output to generate time-domain filter coefficients. For example, the time-domain filter designer 130 can perform inverse transform operations and parameterization operations to generate the time-domain filter coefficients 132 based on the noise-suppression output 128. The time-domain filter coefficients can include, for example, linear phase finite impulse response (FIR) filter coefficients, minimum phase FIR filter coefficients, autoregressive filter coefficients, infinite impulse response (IIR) filter coefficients, or all-pole filter coefficients.

The method 1500 includes, at block 1510, performing time-domain filtering of the second segment using the time-domain filter coefficients to generate a noise-suppressed output signal. For example, the time-domain filter(s) 112 apply the time-domain filter coefficients 132 to a segment (e.g., the second segment) of the audio data 106 that is subsequent to the segment (e.g. the first segment) used to generate the time-domain filter coefficients. One technical advantage of the method 1500 is that the time-domain filter coefficients determined via frequency-domain processing provide high-quality noise suppression, and since the time-domain filter coefficients are applied to received audio data in the time domain, little or no latency is added by using such time-domain filter coefficients to process the audio data.

Optionally, in some implementations, the method 1500 also includes performing adaptive noise cancellation operations based on the noise-suppressed output signal. For example, referring to FIG. 8, the noise-suppressed output signal 114 can be modified using a feedforward ANC filter 812, a feedback ANC filter 816, or a hybrid ANC filter.

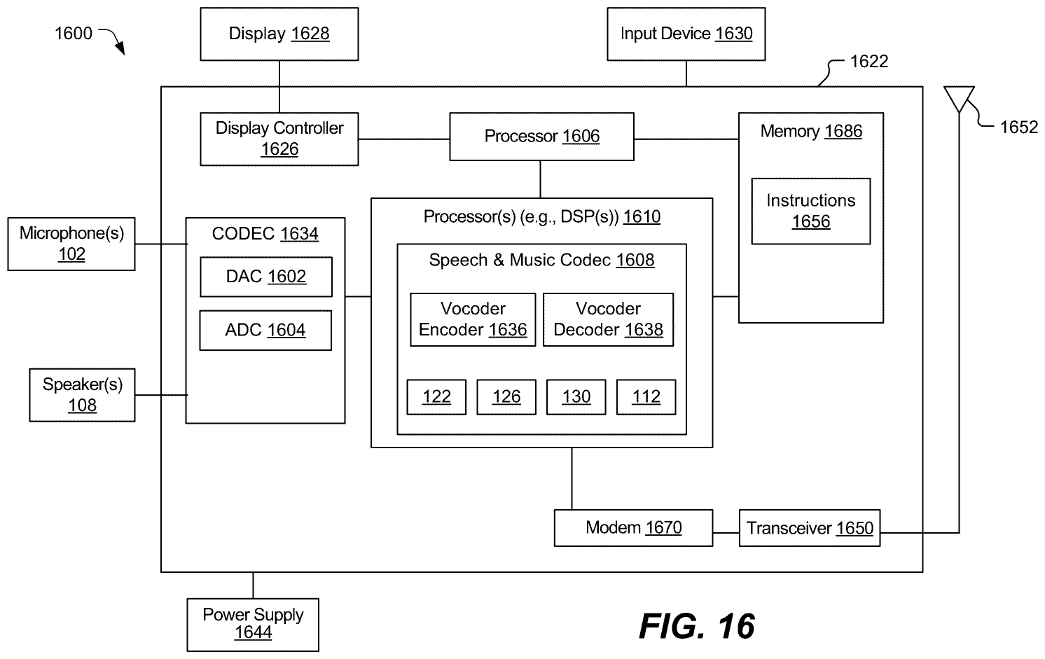

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by one or more processors that execute instructions, such as described with reference to FIG. 16.

Referring to FIG. 16, a block diagram of a particular illustrative implementation of a device is depicted and generally designated 1600. In various implementations, the device 1600 may have more or fewer components than illustrated in FIG. 16. In an illustrative implementation, the device 1600 may correspond to the device 100. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor(s) 190 of FIG. 1 correspond to the processor 1606, the processor(s) 1610, or a combination thereof. The processor(s) 1610 may include a speech and music coder-decoder (CODEC) 1608 that includes a voice coder (“vocoder”) encoder 1636 and a vocoder decoder 1638. The processor(s) 1610 and/or the speech and music CODEC 1608 also include low-latency noise suppression components, such as the analysis filter bank 122, the machine-learning model(s) 126, the time-domain filter designer 130, and the time-domain filter(s) 112.

In FIG. 16, the device 1600 includes a memory 1686 and a CODEC 1634. The memory 1686 includes (e.g., stores) instructions 1656 that are executable by the one or more additional processors 1610 (or the processor 1606) to implement the functionality described with reference to the device 100 of FIG. 1. In FIG. 16, the device 1600 also includes a modem 1670 coupled, via a transceiver 1650, to an antenna 1652. The modem 1670, transceiver 1650, and antenna 1652 enable the device 1600 to exchange data with one or more other devices via wireless communications. For example, in some implementations, the device 1600 can generate audio output at the speaker(s) 108 based on data received via wireless communication with another device.

The device 1600 may include a display 1628 coupled to a display controller 1626. The speaker(s) 108 and the microphone(s) 102 may be coupled to the CODEC 1634. In FIG. 16, the CODEC 1634 includes a digital-to-analog converter (DAC) 1602 and an analog-to-digital converter (ADC) 1604. In a particular implementation, the CODEC 1634 may receive analog signals (e.g., the audio signal(s) 104 of FIGS. 1-8) from the microphone(s) 102, convert the analog signals to digital signals (e.g., the audio data 106 of FIGS. 1-8) using the analog-to-digital converter 1604 and provide the digital signals to the speech and music codec 1608. The speech and music codec 1608 may process the digital signals. The digital signals may further be processed by the analysis filter bank 122, the machine-learning model(s) 126, the time-domain filter designer 130, and the time-domain filter(s) 112. For example, the audio data can be provided to time-domain filter(s) 112 which apply a current set of time-domain filter coefficients to the audio data to generate a noise-suppressed output signal. Additionally, in this example, the audio data can be provided to the analysis filter bank 122 to generate frequency-domain audio data. Input data based on the frequency-domain audio data can be provided to the machine-learning model(s) 126 to generate output data, and a noise-suppression output based on the output data can be provided to the time-domain filter designer 130 to generate updated time-domain filter coefficients. In this example, the updated time-domain filter coefficients can be applied to subsequently received audio data.

In a particular implementation, the speech and music codec 1608 may provide digital signals representing the noise-suppressed output signal and/or other audio content to the CODEC 1634. The CODEC 1634 may convert the digital signals to analog signals using the digital-to-analog converter 1602 and may provide the analog signals to the speaker(s) 108.

In a particular implementation, the device 1600 may be included in a system-in-package or system-on-chip device 1622. In a particular implementation, the memory 1686, the processor 1606, the processors 1610, the display controller 1626, the CODEC 1634, and the modem 1670 are included in the system-in-package or system-on-chip device 1622. In a particular implementation, an input device 1630 and a power supply 1644 are coupled to the system-in-package or the system-on-chip device 1622. Moreover, in a particular implementation, as illustrated in FIG. 16, the display 1628, the input device 1630, the speaker(s) 108, the microphone(s) 102, the antenna 1652, and the power supply 1644 are external to the system-in-package or the system-on-chip device 1622. In a particular implementation, each of the display 1628, the input device 1630, the speaker(s) 108, the microphone(s) 102, the antenna 1652, and the power supply 1644 may be coupled to a component of the system-in-package or the system-on-chip device 1622, such as an interface or a controller.

The device 1600 may include a wearable device, such as a wearable mobile communication device, a wearable personal digital assistant, a wearable display device, a wearable gaming system, a wearable music player, a wearable radio, a wearable camera, a wearable navigation device, a headset, an augmented reality headset, a mixed reality headset, a virtual reality headset, a voice-activated device, a portable electronic device, a wearable computing device, a wearable communication device, a virtual reality (VR) device, one or more earbuds, a hearing aid device, or any combination thereof.

In conjunction with the described implementations, an apparatus includes means for performing one or more transform operations on a first segment of audio data to generate frequency-domain audio data, where the audio data includes a first segment and a second segment subsequent to the first segment. For example, the means for performing the one or more transform operations can correspond to the device 100, the processor(s) 190, the analysis filter bank 122, the processor 1606, the processor(s) 1610, one or more other circuits or components configured to perform one or more transform operations to generate frequency-domain audio data, or any combination thereof.

The apparatus also includes means for processing input data based on the frequency-domain audio data as input to one or more machine-learning models to generate a noise-suppression output. For example, the means for processing the input data can correspond to the device 100, the processor(s) 190, the machine-learning model(s) 126 (optionally along with the input pre-processing engine 820, the output post-processing engine 822, or both), the mask generator 306, the processor 1606, the processor(s) 1610, one or more other circuits or components configured to process input data to generate a noise-suppression output, or any combination thereof.

The apparatus also includes means for performing one or more reverse transform operations on the noise-suppression output to generate time-domain filter coefficients. For example, the means for performing the one or more reverse transform operations can correspond to the device 100, the processor(s) 190, the time-domain filter designer 130, the processor 1606, the processor(s) 1610, one or more other circuits or components configured to perform one or more reverse transform operations, or any combination thereof.

The apparatus also includes means for performing time-domain filtering of the second segment using the time-domain filter coefficients to generate a noise-suppressed output signal. For example, the means for performing time-domain filtering can correspond to the device 100, the processor(s) 190, the time-domain filter(s) 112, the processor 1606, the processor(s) 1610, one or more other circuits or components configured to perform time-domain filtering, or any combination thereof.

In some implementations, a non-transitory computer-readable medium (e.g., a computer-readable storage device, such as the memory 1686) includes instructions (e.g., the instructions 1656) that, when executed by one or more processors (e.g., the one or more processors 1610 or the processor 1606), cause the one or more processors to obtain audio data representing one or more audio signals, the audio data including a first segment and a second segment subsequent to the first segment; perform one or more transform operations on the first segment to generate frequency-domain audio data; provide input data based on the frequency-domain audio data as input to one or more machine-learning models to generate a noise-suppression output; perform one or more reverse transform operations on the noise-suppression output to generate time-domain filter coefficients; and perform time-domain filtering of the second segment using the time-domain filter coefficients to generate a noise-suppressed output signal.

Particular aspects of the disclosure are described below in sets of interrelated Examples:

According to Example 1, a device includes one or more processors configured to obtain audio data representing one or more audio signals, where the audio data includes a first segment and a second segment subsequent to the first segment; perform one or more transform operations on the first segment to generate frequency-domain audio data; provide input data based on the frequency-domain audio data as input to one or more machine-learning models to generate a noise-suppression output; perform one or more reverse transform operations on the noise-suppression output to generate time-domain filter coefficients; and perform time-domain filtering of the second segment using the time-domain filter coefficients to generate a noise-suppressed output signal.

Example 2 includes the device of Example 1, wherein the noise-suppressed output signal is generated with a latency of 1 millisecond or less and the time-domain filter coefficients are generated with a latency of more than 1 millisecond.

Example 3 includes the device of Example 1 or Example 2, wherein the input data includes the frequency-domain audio data.

Example 4 includes the device of any of Examples 1 to 3, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

Example 5 includes the device of any of Examples 1 to 3, wherein the one or more machine-learning models are configured to generate output including noise-suppressed audio data, wherein the one or more processors are configured to determine, based on the noise-suppressed audio data, a frequency mask representing an estimated magnitude of noise in the frequency-domain audio data for each frequency bin of a plurality of frequency bins, and wherein the noise-suppression output includes the frequency mask.

Example 6 includes the device of any of Examples 1 to 5, wherein the one or more machine-learning models include one or more recurrent neural networks.

Example 7 includes the device of any of Examples 1 to 6, wherein, to generate the noise-suppression output, the one or more processors are configured to perform beamforming operations on the frequency-domain audio data to determine beamformed audio data distinguishing a portion of the audio data from a target audio source and a portion of the audio data from a non-target audio source, wherein the input data includes or is based on the beamformed audio data.

Example 8 includes the device of any of Examples 1 to 7, wherein, to process the frequency-domain audio data to generate the noise-suppression output, the one or more processors are configured to perform speech augmentation operations to determine speech-augmented audio data, wherein the input data includes or is based on the speech-augmented audio data.

Example 9 includes the device of any of Examples 1 to 8, wherein, to process the frequency-domain audio data to generate the noise-suppression output, the one or more processors are configured to perform source separation operations to determine source-separated audio data, wherein the input data includes or is based on the source-separated audio data.

Example 10 includes the device of any of Examples 1 to 9, wherein the time-domain filter coefficients include linear phase finite impulse response (FIR) filter coefficients, minimum phase FIR filter coefficients, autoregressive filter coefficients, infinite impulse response (IIR) filter coefficients, or all-pole filter coefficients.

Example 11 includes the device of any of Examples 1 to 10, wherein the one or more processors are integrated into a wearable device.

Example 12 includes the device of any of Examples 1 to 11, wherein the one or more processors are integrated into one or more ear buds.

Example 13 includes the device of any of Examples 1 to 12 and further includes one or more microphones, wherein the one or more audio signals are received from the one or more microphones.

Example 14 includes the device of Example 13 and further includes adaptive noise cancellation circuitry coupled to at least one of the one or more microphones.

Example 15 includes the device of any of Examples 1 to 14 and further includes one or more speakers and one or more microphones coupled to the one or more processors and integrated into a wearable device, wherein the one or more microphones include at least one external microphone configured to generate the audio data and at least one feedback microphone configured to generate a feedback signal based on sound produced by the one or more speakers responsive to the noise-suppressed output signal.

According to Example 16, a method includes obtaining audio data representing one or more audio signals, where the audio data includes a first segment and a second segment subsequent to the first segment; performing one or more transform operations on the first segment to generate frequency-domain audio data; providing input data based on the frequency-domain audio data as input to one or more machine-learning models to generate a noise-suppression output; performing one or more reverse transform operations on the noise-suppression output to generate time-domain filter coefficients; and performing time-domain filtering of the second segment using the time-domain filter coefficients to generate a noise-suppressed output signal.

Example 17 includes the method of Example 16, wherein the noise-suppressed output signal is generated with a latency of 1 millisecond or less and the time-domain filter coefficients are generated with a latency of more than 1 millisecond.

Example 18 includes the method of Example 16 or Example 17, wherein the input data includes the frequency-domain audio data.

Example 19 includes the method of any of Examples 16 to 18, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

Example 20 includes the method of any of Examples 16 to 18, wherein the one or more machine-learning models are configured to generate output including noise-suppressed audio data, and further comprising determining, based on the noise-suppressed audio data, a frequency mask representing an estimated magnitude of noise in the frequency-domain audio data for each frequency bin of a plurality of frequency bins, and wherein the noise-suppression output includes the frequency mask.

Example 21 includes the method of any of Examples 16 to 20, wherein the one or more machine-learning models include one or more recurrent neural networks.

Example 22 includes the method of any of Examples 16 to 21 and further includes performing beamforming operations on the frequency-domain audio data to determine beamformed audio data distinguishing a portion of the audio data from a target audio source and a portion of the audio data from a non-target audio source, wherein the input data is based on or includes the beamformed audio data.

Example 23 includes the method of any of Examples 16 to 22 and further includes performing speech augmentation operations to determine speech-augmented audio data, wherein the input data is based on or includes the speech-augmented audio data.

Example 24 includes the method of any of Examples 16 to 23 and further includes performing source separation operations to determine source-separated audio data, wherein the input data is based on or includes the source-separated audio data.

Example 25 includes the method of any of Examples 16 to 24, wherein the time-domain filter coefficients include linear phase finite impulse response (FIR) filter coefficients, minimum phase FIR filter coefficients, autoregressive filter coefficients, infinite impulse response (IIR) filter coefficients, or all-pole filter coefficients.

Example 26 includes the method of any of Examples 16 to 25, wherein the one or more audio signals are received from one or more microphones.

Example 27 includes the method of any of Examples 16 to 26 and further includes performing adaptive noise cancellation operations based on the noise-suppressed output signal.

According to Example 28, a device includes: a memory configured to store instructions; and a processor configured to execute the instructions to perform the method of any of Examples 16 to 27.

According to Example 29, a non-transitory computer-readable medium stores instructions that, when executed by a processor, cause the processor to perform the method of any of Examples 16 to 27.

According to Example 30, an apparatus includes means for carrying out the method of any of Examples 16 to 27.

According to Example 31, a non-transitory computer-readable medium stores instructions that are executable by one or more processors to cause the one or more processors to obtain audio data representing one or more audio signals, where the audio data includes a first segment and a second segment subsequent to the first segment; perform one or more transform operations on the first segment to generate frequency-domain audio data; provide input data based on the frequency-domain audio data as input to one or more machine-learning models to generate a noise-suppression output; perform one or more reverse transform operations on the noise-suppression output to generate time-domain filter coefficients; and perform time-domain filtering of the second segment using the time-domain filter coefficients to generate a noise-suppressed output signal.

Example 32 includes the non-transitory computer-readable medium of Example 31, wherein the instructions cause the one or more processors to generate the noise-suppressed output signal with a latency of 1 millisecond or less and cause the one or more processors to generate the time-domain filter coefficients with a latency of more than 1 millisecond.

Example 33 includes the non-transitory computer-readable medium of Example 31, wherein the input data includes the frequency-domain audio data.

Example 34 includes the non-transitory computer-readable medium of any of Examples 31 to 33, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

Example 35 includes the non-transitory computer-readable medium of any of Examples 31 to 33, wherein the one or more machine-learning models are configured to generate output including noise-suppressed audio data, wherein the instructions cause the one or more processors to determine, based on the noise-suppressed audio data, a frequency mask representing an estimated magnitude of noise in the frequency-domain audio data for each frequency bin of a plurality of frequency bins, and wherein the noise-suppression output includes the frequency mask.

Example 36 includes the non-transitory computer-readable medium of any of Examples 31 to 35, wherein the one or more machine-learning models include one or more recurrent neural networks.

Example 37 includes the non-transitory computer-readable medium of any of Examples 31 to 36, wherein, to generate the noise-suppression output, the instructions cause the one or more processors to perform beamforming operations on the frequency-domain audio data to determine beamformed audio data distinguishing a portion of the audio data from a target audio source and a portion of the audio data from a non-target audio source, wherein the input data is based on or includes the beamformed audio data.

Example 38 includes the non-transitory computer-readable medium of any of Examples 31 to 37, wherein, to process the frequency-domain audio data to generate the noise-suppression output, the instructions cause the one or more processors to perform speech augmentation operations to determine speech-augmented audio data, wherein the input data is based on or includes the speech-augmented audio data.

Example 39 includes the non-transitory computer-readable medium of any of Examples 31 to 38, wherein, to process the frequency-domain audio data to generate the noise-suppression output, the instructions cause the one or more processors to perform source separation operations to determine source-separated audio data, wherein the input data is based on or includes the source-separated audio data.

Example 40 includes the non-transitory computer-readable medium of any of Examples 31 to 39, wherein the time-domain filter coefficients include linear phase finite impulse response (FIR) filter coefficients, minimum phase FIR filter coefficients, autoregressive filter coefficients, infinite impulse response (IIR) filter coefficients, or all-pole filter coefficients.

Example 41 includes the non-transitory computer-readable medium of Example 40, wherein the instructions cause the one or more processors to perform adaptive noise cancellation operations based on the noise-suppressed output signal.

According to Example 42, an apparatus includes performing one or more transform operations on a first segment of audio data to generate frequency-domain audio data, where the audio data includes a first segment and a second segment subsequent to the first segment; means for processing input data based on the frequency-domain audio data as input to one or more machine-learning models to generate a noise-suppression output; means for performing one or more reverse transform operations on the noise-suppression output to generate time-domain filter coefficients; and means for performing time-domain filtering of the second segment using the time-domain filter coefficients to generate a noise-suppressed output signal.

Example 43 includes the apparatus of Example 42, wherein the means for performing time-domain filtering is operable to generate the noise-suppressed output signal with a latency of 1 millisecond or less, and wherein the means for performing the one or more transform operations, the means for processing the input data, and the means for determining the time-domain filter coefficients are operable to generate the time-domain filter coefficients with a latency of more than 1 millisecond.

Example 44 includes the apparatus of Example 42, wherein the input data includes the frequency-domain audio data.

Example 45 includes the apparatus of any of Examples 42 to 44, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

Example 46 includes the apparatus of any of Examples 42 to 44, wherein the one or more machine-learning models are configured to generate output including noise-suppressed audio data, further comprising means for determining, based on the noise-suppressed audio data, a frequency mask representing an estimated magnitude of noise in the frequency-domain audio data for each frequency bin of a plurality of frequency bins, and wherein the noise-suppression output includes the frequency mask.

Example 47 includes the apparatus of any of Examples 42 to 46, wherein the one or more machine-learning models include one or more recurrent neural networks.

Example 48 includes the apparatus of any of Examples 42 to 47 and further includes means for performing beamforming operations on the frequency-domain audio data to determine beamformed audio data distinguishing a portion of the audio data from a target audio source and a portion of the audio data from a non-target audio source, wherein the input data is based on or includes the beamformed audio data.

Example 49 includes the apparatus of any of Examples 42 to 48 and further includes means for performing speech augmentation operations to determine speech-augmented audio data, wherein the input data is based on or includes the speech-augmented audio data.

Example 50 includes the apparatus of any of Examples 42 to 49 and further includes means for performing source separation operations to determine source-separated audio data, wherein the input data is based on or includes the source-separated audio data.

Example 51 includes the apparatus of any of Examples 42 to 50, wherein the time-domain filter coefficients include linear phase finite impulse response (FIR) filter coefficients, minimum phase FIR filter coefficients, autoregressive filter coefficients, infinite impulse response (IIR) filter coefficients, or all-pole filter coefficients.

Example 52 includes the apparatus of any of Examples 42 to 51, wherein the means for performing time-domain filtering, the means for performing the one or more transform operations, the means for processing the input data, and the means for performing the one or more reverse transform operations are integrated into a wearable device.

Example 53 includes the apparatus of any of Examples 42 to 52, wherein the means for performing time-domain filtering, the means for performing the one or more transform operations, the means for processing the input data, and the means for performing the one or more reverse transform operations are integrated into one or more ear buds.

Example 54 includes the apparatus of any of Examples 42 to 53 and further includes means for generating the one or more audio signals based on ambient sound.

Example 55 includes the apparatus of any of Examples 42 to 54 and further includes means for performing adaptive noise cancellation based on the noise-suppressed output signal.

Example 56 includes the apparatus of any of Examples 42 to 55 and further includes means for generating output sound based on the noise-suppressed output signal; means for generating a feedback signal based on the output sound; and means for performing adaptive noise cancellation based on the noise-suppressed output signal and the feedback signal.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain audio data representing one or more audio signals, the audio data including a first segment and a second segment subsequent to the first segment;
perform one or more transform operations on the first segment to generate frequency-domain audio data;
provide input data based on the frequency-domain audio data as input to one or more machine-learning models to generate a noise-suppression output;
perform one or more reverse transform operations on the noise-suppression output to generate time-domain filter coefficients; and
perform time-domain filtering of the second segment using the time-domain filter coefficients to generate a noise-suppressed output signal.

2. The device of claim 1, wherein the input data includes the frequency-domain audio data.

3. The device of claim 1, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

4. The device of claim 1, wherein the one or more machine-learning models are configured to generate output including noise-suppressed audio data, wherein the one or more processors are configured to determine, based on the noise-suppressed audio data, a frequency mask representing an estimated magnitude of noise in the frequency-domain audio data for each frequency bin of a plurality of frequency bins, and wherein the noise-suppression output includes the frequency mask.

5. The device of claim 1, wherein, to generate the noise-suppression output, the one or more processors are configured to perform beamforming operations on the frequency-domain audio data to determine beamformed audio data distinguishing a portion of the audio data from a target audio source and a portion of the audio data from a non-target audio source, wherein the input data includes the beamformed audio data.

6. The device of claim 1, wherein, to process the frequency-domain audio data to generate the noise-suppression output, the one or more processors are configured to perform speech augmentation operations to determine speech-augmented audio data, wherein the input data includes the speech-augmented audio data.

7. The device of claim 1, wherein, to process the frequency-domain audio data to generate the noise-suppression output, the one or more processors are configured to perform source separation operations to determine source-separated audio data, wherein the input data includes the source-separated audio data.

8. The device of claim 1, wherein the time-domain filter coefficients include linear phase finite impulse response (FIR) filter coefficients, minimum phase FIR filter coefficients, autoregressive filter coefficients, infinite impulse response (IIR) filter coefficients, or all-pole filter coefficients.

9. The device of claim 1, wherein the one or more processors are integrated into a wearable device.

10. The device of claim 1, further comprising one or more microphones, wherein the one or more audio signals are received from the one or more microphones.

11. The device of claim 10, further comprising an adaptive noise cancellation filter coupled to at least one of the one or more microphones.

12. The device of claim 1, further comprising one or more speakers and one or more microphones coupled to the one or more processors and integrated into a wearable device, wherein the one or more microphones include at least one external microphone configured to generate the audio data and at least one feedback microphone configured to generate a feedback signal based on sound produced by the one or more speakers responsive to the noise-suppressed output signal.

13. A method comprising:
obtaining audio data representing one or more audio signals, the audio data including a first segment and a second segment subsequent to the first segment;
performing one or more transform operations on the first segment to generate frequency-domain audio data;
providing input data based on the frequency-domain audio data as input to one or more machine-learning models to generate a noise-suppression output;
performing one or more reverse transform operations on the noise-suppression output to generate time-domain filter coefficients; and
performing time-domain filtering of the second segment using the time-domain filter coefficients to generate a noise-suppressed output signal.

14. The method of claim 13, wherein the input data includes the frequency-domain audio data.

15. The method of claim 13, wherein the one or more machine-learning models are configured to generate output including a frequency mask representing an estimated magnitude of noise in the frequency-domain audio data for each frequency bin of a plurality of frequency bins, and wherein the noise-suppression output includes the frequency mask.

16. The method of claim 13, wherein the one or more machine-learning models are configured to generate output including noise-suppressed audio data, and further comprising determining, based on the noise-suppressed audio data, a frequency mask representing an estimated magnitude of noise in the frequency-domain audio data for each frequency bin of a plurality of frequency bins, and wherein the noise-suppression output includes the frequency mask.

17. The method of claim 13, further comprising performing beamforming operations on the frequency-domain audio data to determine beamformed audio data distinguishing a portion of the audio data from a target audio source and a portion of the audio data from a non-target audio source, wherein the input data includes the beamformed audio data.

18. The method of claim 13, further comprising performing speech augmentation operations to determine speech-augmented audio data, wherein the input data includes the speech-augmented audio data.

19. The method of claim 13, further comprising performing source separation operations to determine source-separated audio data, wherein the input data includes the source-separated audio data.

20. A non-transitory computer-readable medium storing instructions that are executable by one or more processors to cause the one or more processors to:
obtain audio data representing one or more audio signals, the audio data including a first segment and a second segment subsequent to the first segment;
perform one or more transform operations on the first segment to generate frequency-domain audio data;
provide input data based on the frequency-domain audio data as input to one or more machine-learning models to generate a noise-suppression output;
perform one or more reverse transform operations on the noise-suppression output to generate time-domain filter coefficients; and
perform time-domain filtering of the second segment using the time-domain filter coefficients to generate a noise-suppressed output signal.
